(19) United States
(12) Patent Application Publication
(10) Pub. No.: US 2025/0114725 A1
(43) Pub. Date: Apr. 10, 2025

(54) Method For Recycling Alkaliating Solvent

(71) Applicant: Nanoscale Components, Inc., Bedford, NH (US)

(72) Inventors: Christopher J. ALLEN, Brookline, NH (US); Suraj S. DESPHANDE, Windham, NH (US); Robert W. GRANT, Lecanto, FL (US); Asela Maha ACHARIGE, Brookline, NH (US); Joanna L. Sparkes TURTELTAUB, Mansfield, MA (US); Ronald A. WOHL, Woodside, CA (US)

(21) Appl. No.: 18/890,147

(22) Filed: Sep. 19, 2024

Related U.S. Application Data
(60) Provisional application No. 63/554,290, filed on Feb. 16, 2024.
(60) Provisional application No. 63/539,160, filed on Sep. 19, 2023.

(51) Int. Cl. B01D 19/00

(52) U.S. Cl. CPC B01D 19/0084

(57) ABSTRACT

The present invention relates to methods of removing the byproduct halogen gas trapped in anhydrous organic solvents such as gamma-butyrolactone, wherein the trapped species preferably form alkali metal complexes such as alkali metal superhalides, comprising adding lithium oxide or ammonia.

### RELATED APPLICATIONS

This application claims the benefit of U.S. Provisional Application No. 63/539,160, filed on Sep. 19, 2023 and U.S. Provisional Application No. 63/554,290, filed on Sep. 19, 2023. The entire teachings of the above applications are incorporated herein by reference.

### BACKGROUND OF THE INVENTION

Methods for prelithiating materials involve the introduction of lithium ions into and/or on a material, such as an anode. One such method includes U.S. Pat. No. 9,598,789 to Grant, et al. incorporated herein by reference in its entirety. In one embodiment of the method, lithium chloride is dissolved in an anhydrous organic solvent, such as gamma-butyrolactone (GBL). At the time the '789 patent was filed, it was believed that the halide ion formed a gaseous by-product (e.g., Cl₂). However, the identification of the contaminants and byproducts formed during alkaliation has remained elusive. It is desirable to recycle the anhydrous organic solvent. In WO2023/147039, new methods for removing contaminants using ion exchange resins were developed. While the process showed promise, resin degradation over time continued to be a concern. Therefore, methods of removing contaminants from organic solvents, particularly anhydrous organic solvents, are needed.

### SUMMARY OF THE INVENTION

The invention is based, in part, on the discovery that halide ions released (e.g., in a gaseous form such as Cl₂) into an anhydrous organic solvent, such as GBL, during alkaliation become trapped in the solvent by forming a complex with the ion alkali metal, such as superhalide alkali metal complexes (e.g., superhalide lithium). The invention relates to methods of removing these trapped species from organic solvents. In one embodiment, the invention relates to a process for contacting an organic solvent comprising a superhalide alkali metal complex, such as a stream from an alkaliation process with an alkali metal salt, with lithium oxide, such as a suspension of lithium oxide in a solvent. In another embodiment, the invention relates to a process for contacting an organic solvent comprising a superhalide alkali metal complex with ammonia, such as injecting ammonia gas into the solvent, or mixing the solvent with an ammonia-containing solvent. The invention includes a method of alkaliating a material in an anhydrous organic solvent comprising the steps:
(a) providing the material;
(b) providing a bath comprising an anhydrous organic solvent having at least one dissolved alkali halide salt, wherein said bath contacts the material, preferably in a continuous process;
(c) providing an electrolytic field plate wherein said field plate establishes a field between the material and the field plate;
(d) applying a reducing current to the material and an oxidizing current to the field plate, wherein alkali ions from the bath alkaliate into the material, thereby producing an alkaliated material and a waste solution;
(e) contacting the waste solution with ammonia to form a precipitate and a reformed organic solvent; and
(f) removing the precipitate.

The invention also provides a method of lithiating a material in anhydrous gamma-butyrolactone comprising the steps:
(a) providing the material;
(b) providing a bath comprising anhydrous gamma-butyrolactone comprising lithium chloride, wherein said bath contacts the material, preferably in a continuous process;
(c) providing an electrolytic field plate wherein said field plate establishes a field between the material and the field plate;
(d) applying a reducing current to the material and an oxidizing current to the field plate, wherein lithium ions from the bath lithiate into the material, thereby producing a lithiated material and a waste solution comprising a lithium superchloride;
(e) contacting the waste solution with ammonia to form a precipitate and a reformed organic solvent; and
(f) removing the precipitate.

The invention provides a method of reforming an organic solvent comprising lithium superhalide comprising (a) contacting the organic solvent with ammonia thereby forming a precipitate and a reformed organic solvent; and (b) removing the precipitate.

### DETAILED DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

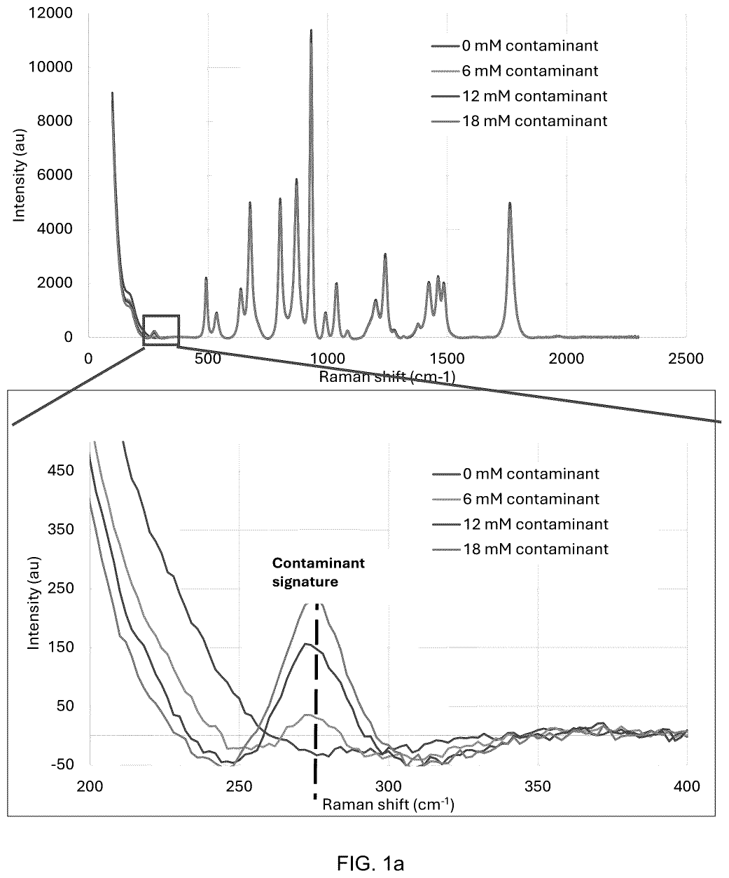

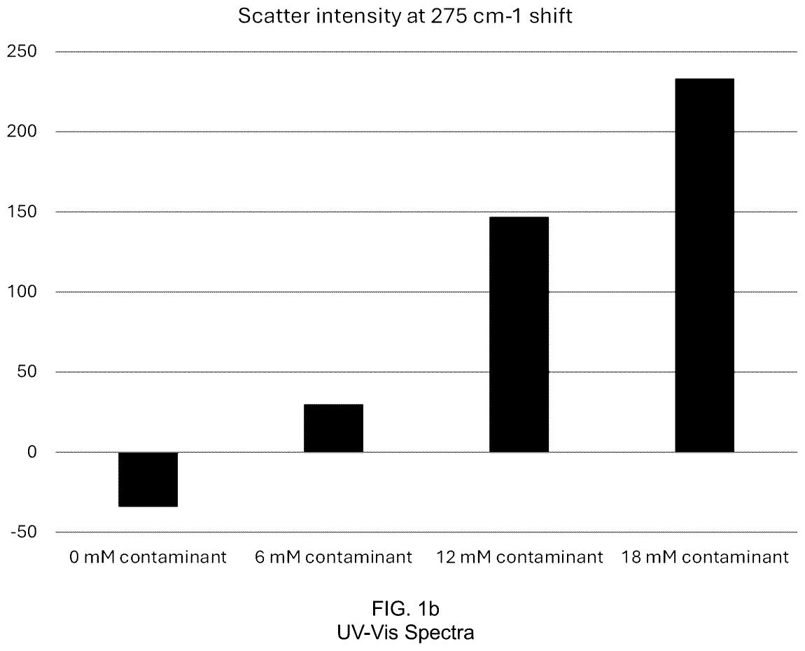

FIG. 1a: Raman Spectra showing the presence of the generated Chlorine (Cl₂) during the prelithiation process. Four separate process fluid samples with increasing Cl₂ concentration (0 mM, 6 mM, 12 mM, and 18 mM Cl⁻, as calculated from prelithiation current) were analyzed by Raman Spectroscopy. FIG. 1b compares the scatter intensities of the four samples at Raman shift=275 cm⁻¹.

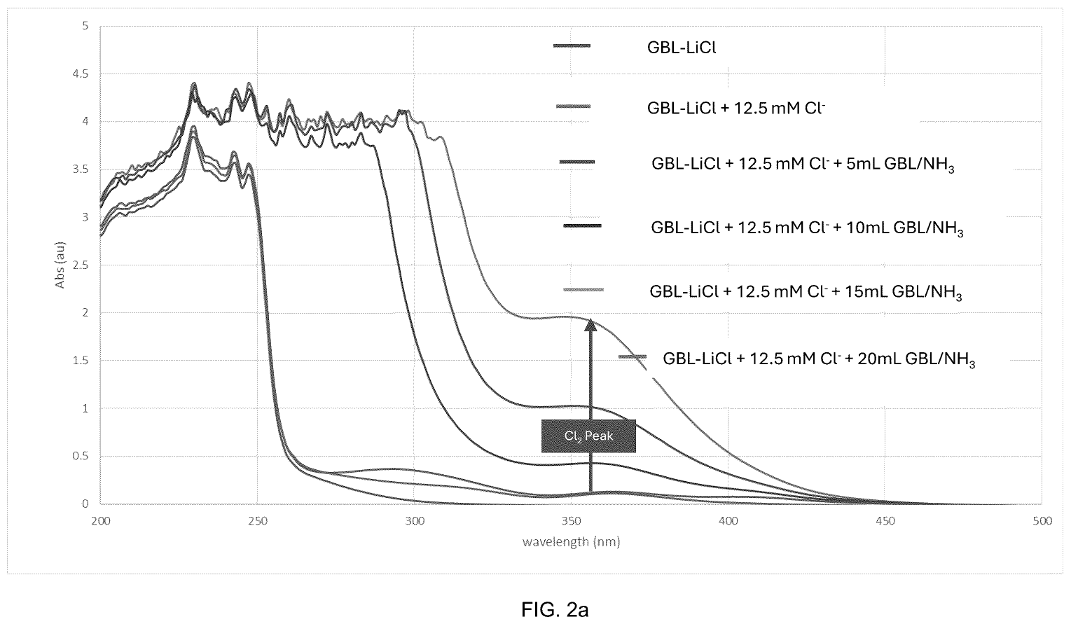

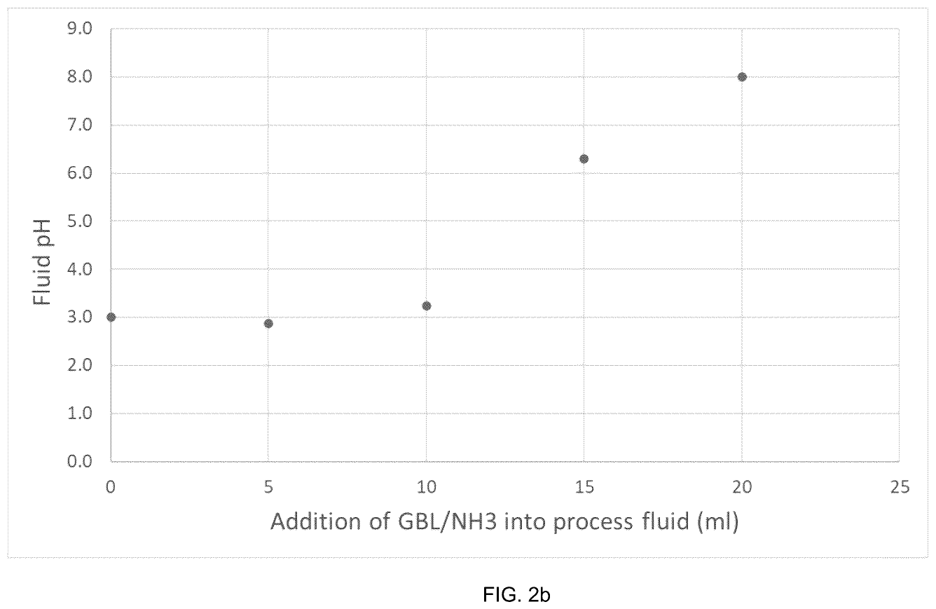

FIG. 2a: UV-Vis Spectra showing the effective removal of the trapped Cl₂ from the process fluid. Aliquots of anhydrous GBL containing ammonia (NH₃) were sequentially added to the process fluid that contained GBL, LiCl and 12.5 mM Cl⁻ to observe the effects of the additions of 0 mL, 5 mL, 10 mL, 15 mL, and 20 mL NH₃ containing GBL. The unprocessed fluid that does not contain Cl₂ was measured as comparison. The Cl₂ peak diminished with increasing the amount of the NH₃ containing GBL to 10 ml. With the addition of NH₃ containing GBL to contaminated process fluid, precipitate formed as the inventors observed white particles after filtration. FIG. 2b shows the changes in pH values of the process fluid with adding the aliquots of NH₃ containing GBL.

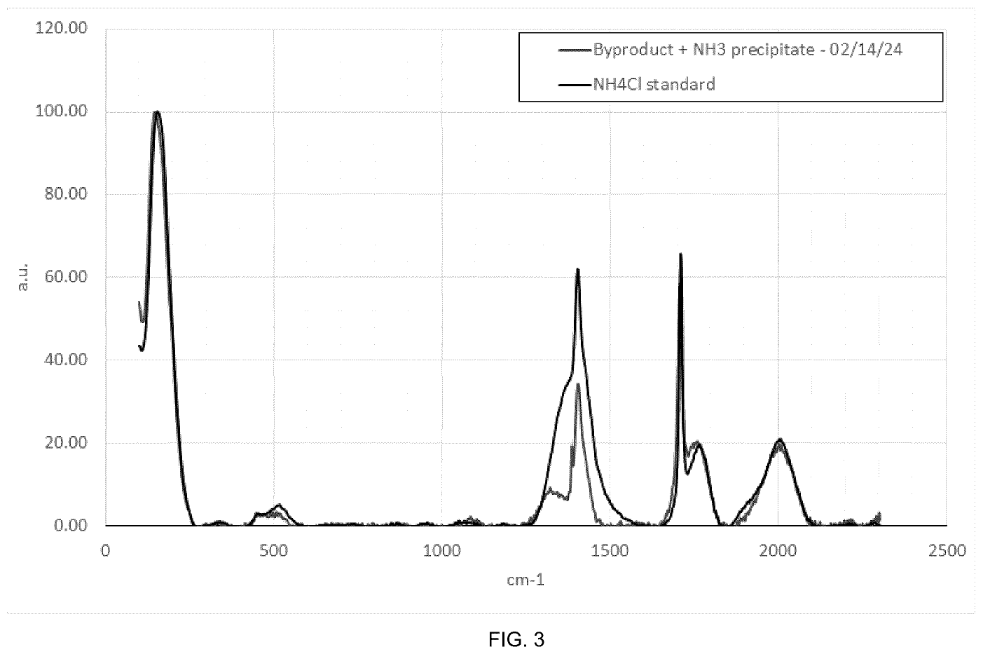

FIG. 3: Raman spectrum confirming the formation NH₄Cl.

### DETAILED DESCRIPTION OF THE INVENTION

The invention is based, in part, on the discovery that halide ions released into an anhydrous organic solvent, such as GBL, during alkaliation with an alkali metal salt form complexes (e.g., superhalide alkali metal complexes). Thus, in one embodiment, the invention includes a composition comprising an organic solvent and a complex such as a superhalide alkali metal complex.

The term “alkali metal halide” means a salt comprising an alkali metal ion and a halide in a 1:1 ratio, MX, wherein M is an alkali metal ion (such as lithium, sodium, potassium, rubidium and cesium, preferably lithium), X is a halide ion, such as F⁻, Cl⁻, Br or I⁻, preferably Cl⁻. A preferred alkali metal halide is lithium chloride. It is intended that lithium halide is the preferred alkali metal halide in each instance the term is used, as if specifically recited in each instance, and is not intended to be a selection from within a list.

The term “superhalide alkali metal complex” (or “alkali metal superhalides”) is defined as the reaction product of one or more halide atoms or ions and a lithium halide dissolved in an organic solvent, such as gamma butyrolactone. Superhalide lithium complexes have been theoretically described, for example (Milovanovic J. Comput. Chem. 2021; 1-10, which is incorporated herein by reference). Superhalide alkali metal complexes are characterized by a molecular formula of MₙXₘ where M is an alkali metal ion (such as lithium, sodium, potassium, rubidium and cesium, preferably lithium), X is a halide ion, such as F⁻, Cl⁻, Br or I⁻, preferably Cl⁻, and m and n are each integers (e.g., 1, 2, 3, 4, 5, 6, 7, 8, 9, 10 or more) where m>n and/or m+n=3 or more. Examples of lithium superhalides include but are not limited to:

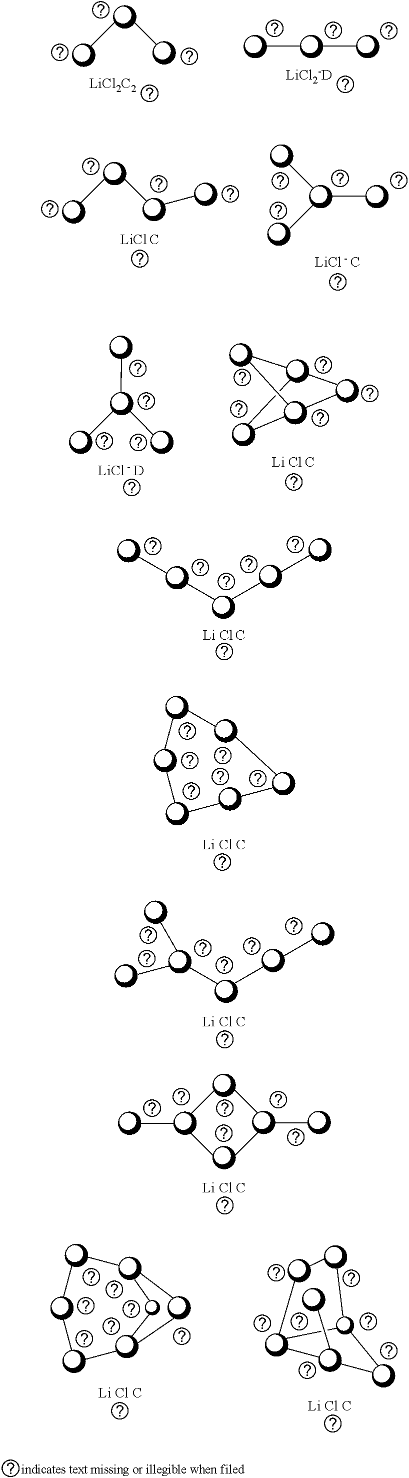

The composition of the invention can comprise one or more distinct superhalide alkali metal complexes (such as superchloride lithium complexes) and optionally an alkali metal halide (such as lithium chloride). For example, the composition can comprise 2 or more complexes selected from the group consisting of LiCl₂, LiCl₃, Li₂Cl₃, Li₂Cl₄, etc. and ionized species and LiCl. Typically, the alkali metal complexed to a superhalide, MₙXₘ, is the same as the alkali metal of the alkali halide, MX, (e.g., M is lithium in each of the superhalide alkali metal complexes and the alkali metal). Likewise, each halide, X, in the superhalide, MₙXₘ, is the same as the halide, X, in the alkali metal halide, MX (e.g., chloride).

The composition further comprises an organic, or non-aqueous, solvent. Preferred organic solvents include solvents that conduct an electric current, or electrolyte. More preferably the solvent is selected from gamma-butyrolactone (GBL), butylene carbonate, propylene carbonate, ethylene carbonate (EC), vinylene carbonate (VC), vinyl ethylene carbonate (VEC), dimethyl carbonate, diethyl carbonate, dipropyl carbonate, methyl ethyl carbonate, acetonitrile), triglyme, tetraglyme, dimethylsulfoxide, dioxolane, sulfolane, room temperature ionic liquids, and mixtures thereof. In a particularly preferred embodiment, the non-aqueous solvent is gamma-butyrolactone (GBL). It is intended that GBL is the preferred solvent in each instance the term “solvent” is used, as if specifically recited in each instance, and is not intended to be a selection from within a list. The organic solvent is preferably anhydrous.

As the composition is preferably produced by and intended to be recycled to an alkaliation (e.g., lithiation) process for alkaliating (e.g., lithiating) electrodes, the non-aqueous solvent can contain an additive that facilitates the formation of a high-quality SEI layer. For example, VC, EC, VEC, CO₂ and mixtures thereof could be added to the non-aqueous solvent.

A preferred composition consists essentially of an organic solvent (e.g., gamma-butyrolactone), one or more superhalide alkali metal complexes (e.g., lithium superchloride complexes), dissolved chlorine (Cl₂) and, optionally the corresponding alkali metal (e.g., lithium chloride). A composition “consisting essentially of” is intended to describe a composition that is produced by an alkaliation process, such as those described herein, without the introduction of any additional components or additives that are detrimental to the alkaliation process. For example, a composition “consisting essentially of” GBL, LiₙClₘ, and LiCl is a composition that is recovered, preferably directly, from a lithiation process in which LiCl is dissolved in GBL to lithiate an electrode. Preferred alkaliation/lithiation processes include those described in Nanoscale Components, Inc. patents, U.S. Pat. Nos. 9,598,789, 10,128,491, 9,748,599, 10,128,487, 11,005,088, and 11,380,879, each of which is incorporated herein by reference.

Without being bound by theory, it is believed that during the lithiation process, chloride ions dissolved in gamma-butyrolactone react with dissolved lithium chloride to form lithium chloride complexes. Experiments have been conducted to show that the chloride ions may not react with GBL under certain conditions for lithiation or release as chloride gas into the headspace of the reactor. Rather, the inventors have discovered that the released chloride ions are complexed with lithium chloride to form a complex. The liberated chloride ions from LiCl due to the lithiation process are converted into chlorine gas (Cl₂). With the presence of lithium chloride in the solvent, the generated chlorine gas cannot escape but forms complexes in the solvent. The inventors have also discovered that the complex can be quickly converted to lithium chloride, such as by adding lithium oxide, significantly improving on recycling the alkaliation/lithium bath. The inventors have also discovered that halide ions (e.g., excess chloride ions) can be removed from the organic solvent, and alkali metal superhalide complex, by adding ammonia.

Thus, in an embodiment, the invention includes a process of converting alkali metal superhalides to lithium chloride in an organic or non-aqueous solvent, such as GBL. In the process, a composition comprising alkali metal superhalides (e.g., lithium superchloride) and an organic solvent (e.g., GBL) is mixed with an alkali metal oxide, such as lithium oxide (Li₂O) thereby forming a composition comprising alkali metal halide (e.g., lithium chloride) in organic or non-aqueous solvent. In a second process, a composition comprising halides and/or alkali metal superhalides (e.g., lithium superchloride) and an organic solvent (e.g., GBL) is mixed with ammonia (such as gaseous ammonia in the same or different miscible organic solvent), thereby forming a precipitate which can then, optionally, be recovered or removed, e.g., by filtration. In a preferred embodiment, an alkaliation (e.g., lithiation) bath obtained from an alkaliation process is used. The feedstock added to the alkaliation/lithiation bath comprises the non-aqueous or organic, solvent, (e.g., a solvent comprising GBL) and an alkali metal halide (MX, e.g., LiCl). Upon dissolution of the alkali metal halide (e.g., LiCl), lithium and chloride ions are dissociated into the bath. During alkaliation, the halide ions are believed to form the superhalide alkali metal complexes. Therefore, the lithiation bath is a composition comprising, or consisting essentially of, preferably GBL, lithium superhalides, and residual unreacted lithium halide and/or ions thereof. For example, the composition is recovered, preferably directly, from a lithiation process in which LiCl is dissolved in GBL to lithiate an electrode. Preferred alkaliation/lithiation processes, and the lithiation compositions or baths, include those described in Nanoscale Components, Inc. patents, U.S. Pat. Nos. 9,598,789, 10,128,491, 9,748,599, 10,128,487, 11,005,088, and 11,380,879, each of which is incorporated herein by reference.

In some embodiments, the invention includes a process of converting the complexes (such as lithium superchlorides) to a halide precipitate in an organic or non-aqueous solvent (such as GBL), thereby allowing the removal of the trapped Cl₂. The composition comprising the halides (e.g., LiCl), the trapped Cl₂ (in the form of lithium complexes such as lithium superchlorides) and an organic solvent (e.g., GBL) is mixed with ammonia (such as gaseous ammonia in the same organic solvent like GBL), thereby forming a precipitate which is then removed, e.g., by filtration.

In some embodiments, the invention includes a method of removing trapped halogen gas (such as Cl₂) from a lithiation bath. The method comprises contacting the bath with ammonia, thereby forming a precipitate which is then removed, e.g., by filtration. In some cases, the ammonia is gaseous ammonia contained in the same or different miscible organic solvent of the bath, preferably the same solvent of the bath (e.g., GBL). In some cases, the ammonia is directly injected into the bath. In preferred cases, the ammonia is injected into the bath in a tank different from the tank where lithiation occurs.

In some embodiments, the invention includes a method of purifying the waste stream as described herein. The waste stream is contacted with ammonia, thereby forming a precipitate which is then removed, e.g., by filtration, resulting in a purified solvent. The purified solvent consists essentially of an organic solvent and an alkali metal halide. Preferably, the purified solvent consists essentially of GBL and an alkali metal halide. More preferably, the purified solvent consists essentially of GBL and LiCl. In some cases, the purified solvent can then be used for lithiation. In some cases, the purified solvent is returned to the lithiation bath.

In some embodiments, the terms “prelithiation” and “lithiation” are used interchangeably. The lithiation process is preferably carried out using lithium chloride dissolved in GBL. Gamma-butyrolactone (GBL) has a capable electrochemical window, including the lithium potential near −3 volts vs. a standard hydrogen electrode (SHE). GBL is an organic solvent with high permittivity and low freezing point and can dissolve and ionize up to about 0.5 M concentration of LiCl. A modest amount of heat can be used to reach this value. In one embodiment, the heat to dissolve and ionize up to a 1 M concentration of LiCl is between about 25° C. and 65° C. In a more preferred embodiment, the heat is between about 30° C. and 55° C. In a most preferred embodiment, the heat is about 40° C. Dissolved gas such as CO₂ or SO₂ can enhance the lithiation process. It increases the solubility of the salt, the ionic conductivity of the non-aqueous solvent, and increases the efficiency of lithiation. Since CO₂ is inexpensive, easily dried, chemically safe, and a potential building block gas for a high-quality SEI layer, it has been selected as the preferred dissolved gas. CO₂ preferentially reacts with trace H₂O and Li⁺ during the lithiation process to form a stable, insoluble SEI material (Li₂O, Li₂CO₃ etc.). Residual CO₂ and its byproducts may be found in the resulting lithiation bath and is intended to be included with the composition consisting essentially of GBL, lithium superhalides and lithium halide.

Alkali metal halide salt (e.g., LiCl) can be added to the non-aqueous solvent using a salt dosing unit. An excess of solid lithium salt can be maintained within the dosing unit to keep the lithium salt concentration within the bath at the desired level (i.e., a saturated solution of about 0.5 M) over long periods of time. The dosing unit can be configured to keep solid salt from entering the bath. In a preferred embodiment, the lithium halide salt within the salt dosing unit is LiCl. The lithiation process can be continuous, semi-continuous or batch. Lithiated electrodes (e.g., anodes) can be removed from the lithiation bath and rinsed. A preferred solvent for rinsing the electrodes is GBL. The GBL rinse can then be directed to the recycle stream for purification.

The lithiation bath can be removed from the lithiation vessel(s), thereby forming a recycle stream. The recycle stream can optionally be filtered to remove any undesirable solids and/or dried (e.g., via distillation) to remove any water.

The recycle stream can then be directed to the recovery unit where the lithiation composition, such as a composition of the invention comprising organic solvent, alkali metal superhalides and optionally alkali metal halide can be treated. The process comprises the step of adding Li₂O to a recycle stream removed from the lithiation tank, or a composition comprising an organic solvent and a superhalide alkali metal complex. The Li₂O can be added as a solid, dispersion or solution, preferably as a solid or dispersion. It is particularly advantageous to suspend Li₂O in the same solvent or solvents used in the lithiation bath or in the composition. Li₂O is easily suspendable in GBL. In one embodiment, the composition comprising GBL, lithium superhalides and lithium chloride (such as the recycle stream) can be mixed with a GBL/Li₂O suspension. The reaction quickly occurs at room temperature and still more quickly at elevated temperatures. The resulting liquor or solution comprising the organic solvents (e.g., GBL) and alkali metal halide (LiCl) can then be removed and optionally returned to the alkaliation/lithiation process. In one embodiment, upon mixing the recycle stream and the Li₂O solid or suspension, pressure resulting from fluid flow creates a porous cake of the Li₂O, thereby facilitating intimate contact between the Li₂O and dissolved lithium superchlorides and improving completeness of the reaction. In one embodiment, the fluid flow is upstream in a tube characterized by a filter at the top. The advantage to this design is that, upon releasing the pressure in the recovery unit, the porous cake of Li₂O releases and can fall into the tube via gravity. The byproduct of the Li₂O and lithium superhalide is oxygen gas and lithium chloride, LiCl, which remains in solution in the GBL.

The GBL LiCI solution thus formed can be easily recycled to the lithiation bath.

As discussed above, the invention relates to the removal of trapped halogens (e.g. chlorine gas), from an electrolyte comprising an organic solvent, such as halide ions present in the organic solvent in the form of complexes such as an alkali metal superhalide complex. The organic solvent preferably comprises GBL. The organic solvent is preferably anhydrous. The “waste solution or waste stream,” as used herein, means the solution is contaminated compared with the composition of the lithiation bath before the lithiation happens and comprises lithiation byproducts (such as halogen like Cl₂, complexes like alkali metal superhalides) in addition to the beginning solvent such GBL/LiCl. In some embodiments, therefore, the waste stream is also referred as “contaminated fluid,” “contaminated process fluid,” or “process fluid.” The waste stream comprises the organic solvent used in the alkaliation process. The waste stream, or organic solvent comprising the trapped gas forming complexes, is contacted with an agent that removes the trapped species. In one embodiment, the agent is lithium oxide. In another embodiment, the agent is ammonia and can be added to the waste stream directly as a gas (e.g., bubbled through the waste stream) or dissolved in an organic solvent. The ammonia forms a precipitate that is easily filtered.

In some embodiments, the waste stream is circulated through an ammonia gas injection assembly. In some cases, the ammonia gas injection assembly comprises a flow controller to inject the ammonia gas into the waste stream. The ammonia gas is injected into the waste stream at a rate that is optimized according to the flow rate of the waste stream and speed of the lithiation and circulation process. The rate is optimized based on the rate of generating the trapped gas (e.g., Cl₂).

The reactions between the ammonia and the trapped species can be exemplified by the reaction between the ammonia and Cl₂:

2NH₃+3Cl₂→N₂+6HCl

6NH₃+6HCl→6NH₄Cl

Therefore, in this case the ammonia injection rate can be calculated based on an ammonia to chlorine reaction molar ratio of 8:3 to remove the chlorine from the waste stream.

In some embodiments, the ammonia gas is injected into the waste stream at a rate of about 1 mL/min to 1000 L/hr.

In some embodiments, the ammonia gas is injected into the waste stream at the rate that leads to the molar ratio of ammonia gas: trapped species (such as Cl₂) above about 1. In some cases, the ammonia gas is injected into the waste stream at the rate that the molar ratio of ammonia gas: trapped species (such as Cl₂) is about 1 to about 100, or about 1 to about 10, or about 2, about 3, about 4, about 5, about 6, about 7, about 8, or about 9.

The ammonia injection assembly can be installed onto a tank containing the waste stream (preferably a separate recycling tank from the tank where lithiation occurs) used for removing the trapped species and converting the waste stream to a purified solvent that can be reused for lithiation. Preferably, the ammonia injection assembly is installed onto a separate recycling tank. In some cases, more than one recycling tanks are used to repeat the reactions between ammonia and the trapped species.

The lithiation bath is circulated at a rate to target a steady chlorine concentration in the lithiation bath. The steady chlorine concentration is in the range of about 0.0001 to about 1 mol/L, or about 0.0002 to about 0.5 mol/L, or about 0.0005 to about 0.3 mol/L, or about 0.001 to about 0.2 mol/L. In some cases, the steady chlorine concentration is about 0.001, 0.002, 0.003, 0.004, 0.005, 0.006, 0.007, 0.008, 0.009, or 0.01 mol/L. In some cases, the steady chlorine concentration is about 0.0011, 0.0012, 0.0013, 0.0014, 0.0015, 0.0016, 0.0017, 0.0018, 0.0019, 0.0020, 0.0021, 0.0022, 0.0023, 0.0024, or 0.0025 mol/L.

After the ammonia injection into the waste stream, precipitate particles (e.g., ammonium chloride) are formed and removed preferably by filtration, and thereby achieving a composition free of trapped species, a purified solvent (e.g., GBL and lithium chloride). The purified solvent is then returned to the lithiation bath.

Where the agent is added dissolved in an organic solvent (the “dissolving organic solvent,” for clarity purposes), the dissolving organic solvent is preferably miscible with the organic solvent in the waste stream. Preferably the dissolving organic solvent and the organic solvent in the waste stream are the same and preferably comprise, consist essentially of or consist of GBL. It can be efficient to dissolve the agent in the organic solvent at or near saturation levels at room temperature, which can be empirically determined. However, lesser amounts are possible as well.

The invention relates to a method for recycling, or reforming, an alkaliation/lithiation bath comprising (or consisting essentially of) an organic, non-aqueous solvent (such as GBL) and alkali metal halide and any reaction products thereof (such as superhalide alkali metal complexes) comprising adding lithium oxide to the bath and removing unreacted lithium oxide.

The invention also relates to a method for recycling, or reforming, an alkaliation/lithiation bath comprising (or consisting essentially of) an organic, non-aqueous solvent (such as GBL) and alkali metal halide and any reaction products thereof (such as superhalide alkali metal complexes) comprising adding ammonia to the bath, forming a precipitate and removing the precipitate. The precipitate comprises ammonium chloride. Therefore, the invention also relates to a method for producing ammonium chloride.

A preferred embodiment of the invention includes a method of alkaliating a material in an anhydrous organic solvent comprising the steps:
(a) providing the material;
(b) providing a bath comprising an anhydrous organic solvent having at least one dissolved alkali halide salt, wherein said bath contacts the material, preferably in a continuous process, and wherein a dry gas blanket covers said bath;
(c) providing an electrolytic field plate wherein said field plate establishes a field between the material and the field plate;
(d) applying a reducing current to the material and an oxidizing current to the field plate, wherein alkali ions from the bath alkaliate into the material;
(e) contacting the anhydrous organic solvent with lithium oxide; and
(f) optionally, removing unreacted lithium oxide.

Materials for alkaliation can include anodes and cathodes. Such materials can comprise graphite, coke, carbons, tin, tin oxide, silicon, silicon oxide, aluminum, lithium-active metals, alloying metal materials, and mixtures thereof. Materials can also comprise metal oxides of nickel, aluminum, cobalt, manganese, iron, and mixtures thereof. Materials can also comprise sulfur and phosphorus, and mixtures thereof. Materials can also comprise metal substrate (e.g., copper or nickel).

The processes and methods of the invention are conducted in, or using, organic solvents. Typically, the organic solvent is anhydrous and an electrolyte. The same or different organic solvents can be used in the various steps of the methods or processes. For example, where the invention includes the lithiation of a material, such as an anode, gamma-butyrolactone is a preferred solvent as it dissolves lithium halide, such as lithium chloride. Gamma-butyrolactone has a capable electrochemical window, including the lithium potential near −3 volts vs. a standard hydrogen electrode (SHE). It is a capable solvent with high permittivity and low freezing point, and can dissolve and ionize 0.5 M LiCl. A modest amount of heat can be used to reach this value. In one embodiment, the LiCl solution can be maintained at a temperature between about 20° C. and 65° C., such as between 30° C. and 65° C., such as between 38° C. and 55° C. In a more preferred embodiment, the heat is between about 25° C. and 55° C. In a most preferred embodiment, the heat is about 40° C.

The lithiation tank can also have an internal circulating pump and distribution manifold to prevent localized salt concentration deprivation.

Dissolved gas such as CO₂ can enhance the lithiation process. It increases the solubility of the salt, the ionic conductivity of the non-aqueous solvent, and increases the efficiency of lithiation. Since CO₂ is inexpensive, easily dried, chemically safe, and a potential building block gas for a high-quality SEI layer, it has been selected as the preferred dissolved gas. CO₂ preferentially reacts with trace H₂O and Li⁺ during the lithiation process to form a stable, insoluble SEI material (Li₂O, Li₂CO₃, etc.). The moisture level in the lithiation tank is driven down by the consumption of CO₂ and H₂O according to this process, and care is given to control the moisture level in the tank to between about 0 to 2000 ppm, preferably 5 to 200 ppm, even more preferably 5 to 100 ppm. In this way, anode lithiation with a quality SEI material is produced continuously.

Deposition of lithium ions (or generally lithiation) from 0.25 to 0.5 M LiCl salt, for example, in gamma-butyrolactone solvent will occur at about 4.1 volts measured between the anode sheet and the reference electrode up to a reducing current density of 2 mA/cm² or more. The preferred current density will vary depending on the nature of the electrode to be lithiated. In order to control both the currents and dependent voltages accurately, it may be necessary to divide the field plate into zones. Other metals can also be alloyed or intercalated or plated with this method including sodium as an example. It was first thought that the lithiation process would release chlorine gas. However, it was then discovered that the chlorine remained in the solution. Therefore, methods to remove the halide from the organic solvent were required.

When an anode is lithiated as described above, it can be assembled into a battery or electrochemical cell with a cathode material. The anode, dried cathode and separator are then assembled into a dried cell housing, such as a button cell housing, a pouch cell, a cylindrical cell or a prismatic cell. Electrolyte is added, and the cell is sealed, preferably during an applied vacuum. Preferred electrolytes include EC/DMC/DEC and 1M LiPF6 and 1% VC. The cell is then sealed (e.g., vacuum sealed) and preferably stored at ambient or elevated temperature (between about 15 and 60° C.) for 1 to 24 hours, preferably between 3 and 18 hours, to allow for electrolyte adsorption and swelling and further SEI formation. The cell is then ready for electrochemical cycling.

The invention also includes a method of lithiating a material in anhydrous gamma-butyrolactone comprising the steps:
(a) providing the material;
(b) providing a bath comprising anhydrous gamma-butyrolactone comprising lithium chloride, wherein said bath contacts the material, preferably in a continuous process;
(c) providing an electrolytic field plate wherein said field plate establishes a field between the material and the field plate;
(d) applying a reducing current to the material and an oxidizing current to the field plate, wherein lithium ions from the bath lithiate into the material, thereby producing a lithiated material and a waste solution comprising a lithium superchloride;
(e) contacting the waste solution with ammonia to form a precipitate and a reformed organic solvent; and
(f) removing the precipitate.

In some embodiments, the invention also includes a method of producing ammonium chloride comprising the steps:
(a) providing an anhydrous organic solvent comprising dissolved lithium chloride;
(b) optionally, (i) providing an electrolytic field plate wherein said field plate establishes a field between a material and the field plate immersed in said anhydrous organic solvent and (ii) applying a reducing current to the material and an oxidizing current to the field plate, thereby producing a lithiated material and a waste solution;
(c) contacting the waste solution with ammonia to form a precipitate comprising ammonium chloride and a reformed organic solvent; and
(d) removing the precipitate.

In some cases, the anhydrous organic solvent comprises gamma-butyrolactone.

In some cases, step (c) comprises bubbling gaseous ammonia into the waste solution.

In some cases, step (c) comprises contacting the waste solution with a miscible organic solvent comprising ammonia.

In some cases, the anhydrous organic solvent comprises gamma-butyrolactone and the miscible organic solvent comprises gamma-butyrolactone.

In some cases, the miscible organic solvent comprises or is saturated with ammonia.

In some cases, the precipitate is filtered.

### EXAMPLES

A roll-to-roll prelithiation was carried out using a double-side-coated graphite composite electrode coated on 19 cm wide copper foil. The coated electrode width was 15 cm with 2 cm exposed copper on either edge. The electrode was composed of 95-96% graphite, 0.5-1% conductive additive, 1.3-2.0% CMC and 2.5% SBR. The weight of the graphite composite electrode without foil was 16 mg/cm² and the coating density was 1.5 g/cm³.

Prior to its entry into the lithiation bath, the graphite composite electrode passed through a heated convective air drier set at 60 degree C. and 12 standard cubic feet per minute airflow to remove residual moisture in the graphite composite electrode.

In the prelithiation apparatus, graphite counter electrodes were used on either side of the graphite composite electrode for the chlorine evolving counter electrode with a 15 cm exposed width. Dielectric shields were positioned on the graphite counter electrode to avoid lithiation on the bare copper foil edge.

The electrolyte for prelithiation was thermostatted at 40 degree Celsius and consisted essentially of gamma butyrolactone solvent with 0.3 mol/L dissolved lithium chloride salt along with approximately 0.01 mol/L dissolved carbon dioxide gas. The total electrolyte volume was approximately 11 liters.

The target prelithiation dosage was 0.42 mAh/cm² lithium at 1.75 mA/cm² constant current density. The roll to roll electrolyzer for prelithiation had a wetted web length of 42 cm. To meet the 14 minute electrode resident time in the bath required to achieve the target lithiation dosage the electrode line speed was set at 3 cm/min.

The 2.2 amps of resulting constant current electrolysis in this test led to a chlorine generation rate of 0.04 moles Cl₂/hr in the 11 L bath. Experiments confirmed that Cl₂ can be sparged from the GBL solution without LiCl but cannot with the presence of LiCl. During prelithiation, the generated Cl₂ was substantially trapped in the bath, resulting in a byproduct (e.g., the lithium superchloride as described above). Therefore, during lithiation the electrolyte containing the byproduct was circulated through an ammonia gas injection assembly in order to neutralize the generated chlorine and form ammonium chloride particles suspended in the electrolyte. Ammonia gas was injected into the electrolyte stream at a rate of 40 standard ml/min using a mass flow controller. This ammonia injection rate was calculated based on an ammonia to chlorine reaction molar ratio of 8:3 to remove the chlorine from the fluid stream. Electrolyte was circulated at rate of 360 ml/min to target a steady chlorine concentration of 0.0019 mol/L chlorine in the lithiation bath.

Downstream of the ammonia injection, ammonium chloride particle formed in the fluid stream and was removed by filtration. The electrolyte was then returned to the lithiation bath.

The effect of ammonia in precipitating the trapped chlorine was evaluated by Raman spectroscopy and the results were shown in FIG. 1a. Chloride concentration in the lithiation bath were calculated using the following formula, which takes into account the lithiation current, and duration of lithiation.

$Chloride concentration [ mol / L ] = ( \frac{i \times t}{F} ) \times \frac{1}{{V}_{bath}}$

| | |
|---|---|
| i | Lithiation current in [A] |
| t | Lithiation duration [s] |
| F | Faraday constant [C/mol] (≈96500 C/mol) |
| V_{bath} | Volume of solvent in the lithiation bath [L] |

While there has been illustrated and described what is at present considered to be the preferred embodiment of the present invention, it will be understood by those skilled in the art that various changes and modifications may be made and equivalents may be substituted for elements thereof without departing from the true scope of the invention. Therefore, it is intended that this invention not be limited to the particular embodiment disclosed, but that the invention will include all embodiments falling within the scope of the appended claims.

1. A method of alkaliating a material in an anhydrous organic solvent comprising the steps:
(a) providing the material;
(b) providing a bath comprising an anhydrous organic solvent having at least one dissolved alkali halide salt, wherein said bath contacts the material, preferably in a continuous process;
(c) providing an electrolytic field plate wherein said field plate establishes a field between the material and the field plate;
(d) applying a reducing current to the material and an oxidizing current to the field plate, wherein alkali ions from the bath alkaliate into the material, thereby producing an alkaliated material and a waste solution;
(e) contacting the waste solution with ammonia to form a precipitate and a reformed organic solvent; and
(f) removing the precipitate.

2. The method of claim 1, wherein the dissolved halide salt comprises lithium chloride.

3. The method of claim 1, wherein the anhydrous organic solvent comprises gamma-butyrolactone.

4. The method of claim 1, wherein step (e) comprises bubbling gaseous ammonia into the waste solution.

5. The method of claim 1, wherein step (e) comprises contacting the waste solution with a miscible organic solvent comprising ammonia.

6. The method of claim 5, wherein the anhydrous organic solvent comprises gamma-butyrolactone and the miscible organic solvent comprises gamma-butyrolactone.

7. The method of claim 6, wherein the miscible organic solvent is saturated with ammonia.

8. The method of claim 1, wherein the precipitate is filtered.

9. The method of claim 1, wherein the method produces a purified organic solvent, and the purified organic solvent is added to the anhydrous organic solvent.

10. The method of claim 1, wherein the precipitate is an ammonium salt.

11. The method of claim 10, wherein the ammonium salt is ammonium chloride.

12. A method of purifying an organic solvent comprising a complex formed by halogen gas and alkali metal halide (such as lithium superhalide) comprising (a) contacting the organic solvent with ammonia thereby forming a precipitate and a purified organic solvent; and (b) removing the precipitate.

13. The method of claim 12, wherein the anhydrous organic solvent comprises gamma-butyrolactone.

14. The method of claim 12, wherein gaseous ammonia is bubbled into the organic solvent.

15. The method of claim 12, wherein step (a) comprises contacting the organic solvent with a miscible organic solvent comprising ammonia.

16. The method of claim 15, wherein the organic solvent comprises gamma-butyrolactone and the miscible organic solvent comprises gamma-butyrolactone.

17. The method of claim 16, wherein the miscible organic solvent is saturated with ammonia.

18. The method of claim 12, wherein the precipitate is filtered.

19. A process comprising contacting an organic solvent comprising a superhalide alkali metal complex with ammonia to form a precipitate.

20. The process of claim 19, further comprising filtering the precipitate.

21. The process of claim 19, wherein the organic solvent is gamma-butyrolactone.

22. (canceled)

23. A composition comprising gamma-butyrolactone, lithium chloride, and a trapped chlorine gas, wherein the trapped chlorine gas at least partially forms a complex with lithium chloride.

24. The composition of claim 23, wherein the complex comprises a lithium superchloride.

25. The composition of claim 23, further comprising ammonia.

26. The composition of claim 25, further comprising ammonium chloride.

27. The composition of claim 26, ammonium chloride is in the form of particles suspended in the composition.
